(19) United States
(12) Patent Application Publication
(10) Pub. No.: US 2024/0142787 A1
(43) Pub. Date: May 2, 2024

(54) LASER MODULE, OPTICAL ENGINE MODULE, AND XR GLASSES

(71) Applicant: TDK CORPORATION, Tokyo (JP)

(72) Inventors: Hideaki FUKUZAWA, Tokyo (JP); Tsuyoshi KOMAKI, Tokyo (JP); Ardalan HESHMATI, Saratoga, CA (US)

(73) Assignee: TDK CORPORATION, Tokyo (JP)

(21) Appl. No.: 18/383,642

(22) Filed: Oct. 25, 2023

(30) Foreign Application Priority Data
Oct. 26, 2022 (JP) 2022-171374

(51) Int. Cl. G02B 27/18; G02B 5/00; G02B 6/42; G02B 26/10; G02B 27/01

(52) U.S. Cl. CPC G02B 27/18; G02B 5/005; G02B 6/4257; G02B 26/101; G02B 27/0172; G02B 26/0833

(57) ABSTRACT

A laser module includes a laser light source, a package in which the laser light source is housed and a light transmission window through which laser light output from the laser light source can be optically transmitted is provided on a wall portion, and an output light aperture provided inside or outside of the package and arranged in a traveling direction of the laser light to adjust an area of a passage port of the laser light.

### CROSS-REFERENCE TO RELATED APPLICATION

Priority is claimed on Japanese Patent Application No. 2022-171374, filed Oct. 26, 2022, the content of which is incorporated herein by reference.

### BACKGROUND OF THE INVENTION

### Field of the Invention

The present disclosure relates to a laser module, an optical engine module, and XR glasses.

### Description of Related Art

XR glasses such as augmented reality (AR) glasses and virtual reality (VR) glasses are expected to be small wearable devices. The key to widespread use of wearable devices such as AR glasses and VR glasses is to implement miniaturization so that each function fits within the size of ordinary eyeglasses.

Also, in an alignment process in which an optical axis is aligned between a light outputter for introducing light to an optical waveguide and an end of an optical waveguide due to this miniaturization, a component of light that is not coupled to the optical waveguide is easily generated. There is a problem that this light component propagates in a part other than an optical waveguide in an optical waveguide element, some light is input to a photodetector after multiple reflections on an end surface, and so-called stray light is easily generated. Stray light propagating in the optical waveguide element blocks the alignment of the photodetector, which can cause an increase in connection loss and a connection failure. In particular, when visible light is used as a light source, the optical waveguide becomes smaller and therefore an influence of stray light is large.

To prevent the stray light in such an optical waveguide element from being output toward the photodetector, for example, an optical integrated circuit element in which a groove portion penetrating the optical waveguide layer is provided at a position other than a waveguide portion that guides light and a side surface of the groove portion is tilted to a surface perpendicular to an element surface is disclosed in Patent Document 3.

However, in the technology disclosed in Patent Document 3, because a groove portion that blocks stray light is formed above a surface of a substrate, the groove portion is effective in blocking stray light propagating in a cladding layer, but there is a problem that it is difficult to block stray light propagating in the substrate.

XR glasses such as AR glasses and VR glasses proposed in Patent Documents 1 and 2 are not miniaturized and the optical axis alignment is significantly complicated.

### PATENT DOCUMENTS

[Patent Document 1] United States Patent Application, Publication No. 2020/0081530
[Patent Document 2] United States Patent Application, Publication No. 2020/0150428
[Patent Document 3] Japanese Unexamined Patent Application, First Publication No. H11-52154
[Patent Document 4] Japanese Patent No. 6369147
[Patent Document 5] Japanese Patent No. 6787397

### SUMMARY OF THE INVENTION

The present disclosure has been made in view of the above-described problems and an objective of the present disclosure is to provide a laser module, an optical engine module, and XR glasses capable of implementing miniaturization and making optical axis alignment substantially unnecessary.

The present disclosure provides the following means to solve the above-described problems.

According to a first aspect of the present disclosure, there is provided a laser module including: a laser light source; a package in which the laser light source is housed and a light transmission window through which laser light output from the laser light source can be optically transmitted is provided on a wall portion; and an output light aperture provided inside or outside of the package and arranged in a traveling direction of the laser light to adjust an area of a passage port of the laser light.

According to a second aspect of the present disclosure, there is provided an optical engine module including: the laser module according to the first aspect; and an optical scanning mirror configured to scan light output from the laser module.

According to a third aspect of the present disclosure, there are provided XR glasses comprising the optical engine module according to the second aspect.

According to the aspects of the present disclosure, it is possible to provide a laser module capable of implementing miniaturization and making optical axis alignment substantially unnecessary.

### BRIEF DESCRIPTION OF THE DRAWINGS

FIG. 1A is a conceptual diagram of a laser module according to an embodiment and is a diagram showing a case where an output light aperture is attached outside of a package.

FIG. 1B is a conceptual diagram of a laser module according to an embodiment and is a diagram showing a case where an output light aperture is attached inside of a package.

FIG. 2 is a schematic plan view showing an example of the laser module according to the embodiment.

FIG. 3 is a side view of the laser module shown in FIG. 2 and is a cutaway view of the inside of a part of the laser module.

FIG. 4A is a schematic plan view showing an outline of the output light aperture and is a view showing a case where the output light aperture closes to the maximum.

FIG. 4B is a schematic plan view showing an outline of the output light aperture and is a view showing an intermediate aperture between the case of FIG. 4A and the case of FIG. 4C.

FIG. 4C is a schematic plan view showing an outline of the output light aperture and is a view showing a case where the output light aperture opens to the maximum.

FIG. 5A is a diagram showing a ball plunger, which is an example of a representative plunger used by a positioning mechanism.

FIG. 5B is a diagram showing a pin plunger, which is an example of the representative plunger used by the positioning mechanism.

FIG. 5C is a diagram showing an index plunger, which is an example of the representative plunger used by the positioning mechanism.

FIG. 6 is a schematic perspective view showing a configuration example of the output light aperture when the positioning mechanism is a ball plunger.

FIG. 7 is a schematic longitudinal cross-sectional view of the laser module according to the embodiment cut along an x-axis direction.

FIG. 8 is a schematic plan view seen from a laser light input surface of a PLC.

FIG. 9 is a conceptual diagram of a laser module including an optical waveguide layer having an optical waveguide made of a lithium niobate film.

FIG. 10A is a schematic plan view obtained by enlarging a region surrounding a near-infrared laser light source and an optical waveguide corresponding thereto.

FIG. 10B is a schematic cross-sectional view along line X1-X1 in FIG. 10A.

FIG. 11 is a schematic plan view of the laser module viewed from an output surface of visible laser light and near-infrared laser light.

FIG. 12 is a schematic perspective view showing another configuration example of an output light aperture.

FIG. 13 is a conceptual diagram for describing XR glasses according to the present embodiment.

FIG. 14 is a conceptual diagram showing a state in which an image is directly projected onto a retina by laser light output from the laser module according to the embodiment.

### DETAILED DESCRIPTION OF THE INVENTION

Hereinafter, embodiments will be described in detail with reference to the drawings as appropriate. In the drawings used in the following description, featured parts may be enlarged for convenience such that the features of the present disclosure are easier to understand, and dimensional ratios and the like of the respective components may be different from actual ones. Materials, dimensions, and the like exemplified in the following description are examples, the present disclosure is not limited thereto, and modifications can be appropriately made in a range in which advantageous effects of the present disclosure are exhibited.

### [Laser Module]

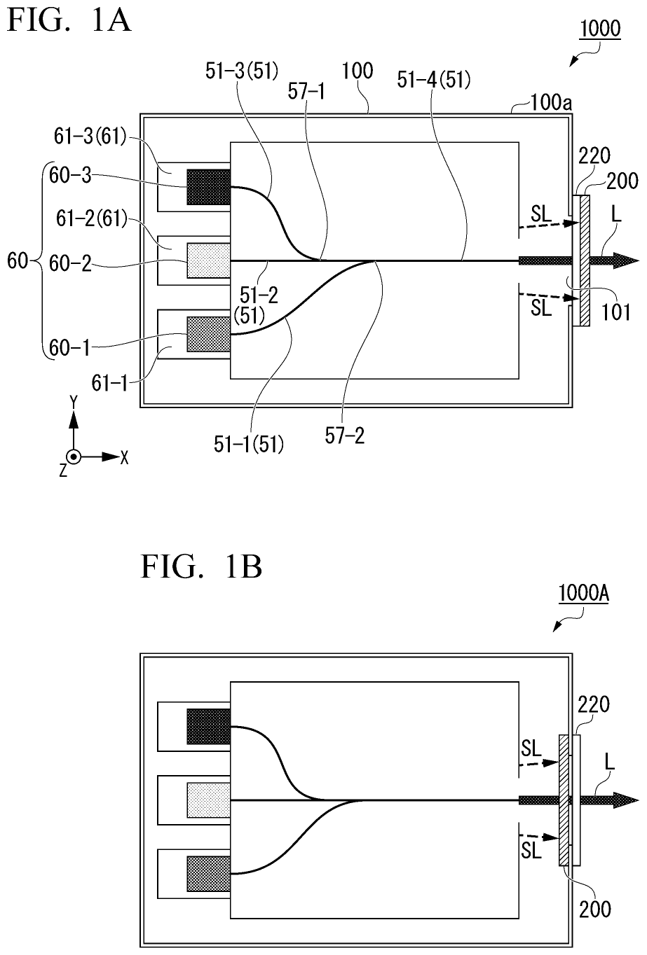

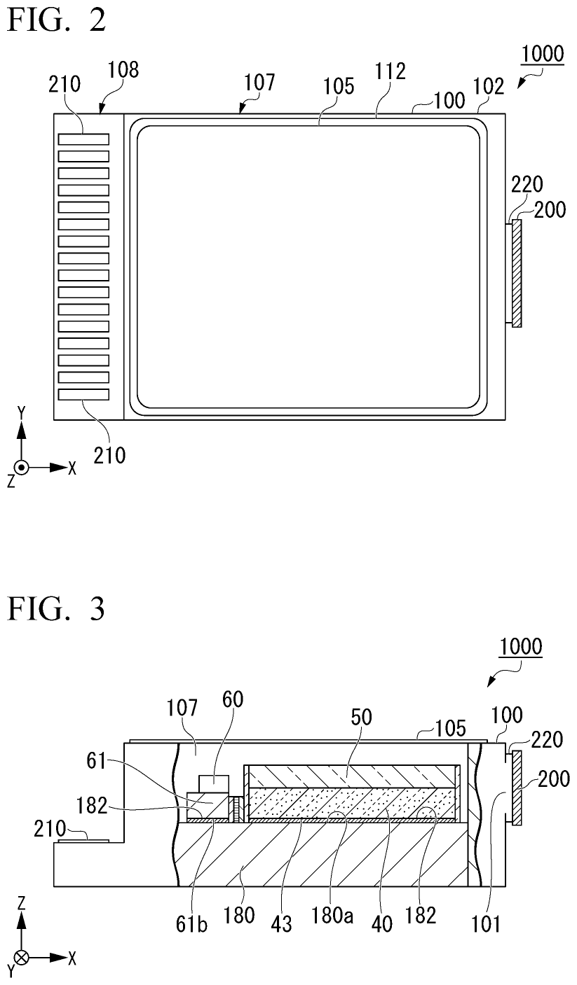

FIGS. 1A and 1B are conceptual diagrams of a laser module according to an embodiment. FIG. 2 is a schematic plan view showing an example of a laser module according to the embodiment. FIG. 3 is a side view of the laser module shown in FIG. 2 and is a cutaway view of the inside of a part of the laser module.

As a laser light source and a package provided in a laser module according to the present embodiment, known devices can be used. Specific examples will be described below.

A laser module 1000 shown in FIG. 1A includes a laser light source 60; a package 100 in which the laser light source 60 is housed and a light transmission window 101 through which laser light L output from the laser light source 60 can be optically transmitted is provided on a wall portion 100a; and an output light aperture 200 provided outside of the package 100 and arranged in a traveling direction of the laser light L to adjust an area of passing of the laser light L.

In FIG. 1A, a dotted arrow indicated by SL indicates a part of stray light and the output light aperture 200 prevents the stray light from leaking out of the laser module 1000.

Although the output light aperture 200 is provided outside of the package 100 in the laser module 1000 shown in FIG. 1A, the output light aperture 200 may be provided inside of the package 100 as in the laser module 1000A shown in FIG. 1B.

Although the laser light sources 60 are three visible laser light sources that output RGB laser light of three colors in the laser module 1000 shown in FIG. 1A, the number and types of laser light sources are merely an example and others are also possible. For example, a near-infrared laser light source that outputs near-infrared light for the purpose of eye tracking or the like may be provided.

### <Package>

The package 100 includes a main body 102 having a cavity structure and a cover 105 covering the main body 102.

The main body 102 has a bottom portion on which members housed therein are placed and a wall portion (sidewall portion) 100a arranged to surround the members from the sides.

A light transmission window 101 through which the laser light L output from the laser light source 60 can be optically transmitted is formed in the wall portion (sidewall portion) 100a arranged in the direction in which the laser light is output.

The light transmission window (opening) 101 is formed in the sidewall portion 100a near the output portion of the laser light L output from the laser module 1000 in the sidewall portion 100a of the housing portion 107. The opening 101 is formed to be substantially centered on a position intersecting the optical axis of the laser light output from the sidewall portion 100a. The opening 101 is tightly covered with the glass plate 220 from the outside of the sidewall portion 100a. That is, the housing portion 107 is hermetically sealed by the glass plate 220 in addition to the cover 105. Although the glass plate 220 is used for airtight sealing, the present disclosure is not limited to the glass plate as long as it is a material through which laser light can pass. An antireflection film (not shown) may be provided on both surfaces of the glass plate 220.

In the laser module 1000 shown in FIG. 1A, the laser light L passes through the light transmitting window (opening) 101, the glass plate 220, and the output light aperture 200 in that order and is output from the laser module 1000.

In the laser module 1000A shown in FIG. 1B, when the output light aperture 200 is provided inside of the package 100, the laser light L passes through the output light aperture 200, the light transmission window (opening) 101, and the glass plate 220 in that order and is output from the laser module 1000A.

In the laser module 1000 shown in FIG. 1A, the main body 102 has a box-shaped housing portion 107 in which the laser light source 60 and the like are housed and an electrode portion 108 adjacent to the housing portion 107. The main body 102 is made of, for example, ceramic or the like. An opening is formed in the upper surface of the housing portion 107. A metallic film 112 such as Kovar is formed on the upper surface of the housing portion 107 at the periphery of the opening when viewed from above. The cover 105 tightly covers the opening formed in the upper surface of the housing portion 107 via the metallic film 112. When the housing portion 107 is hermetically sealed with the cover 105, an internal space of the housing portion 107 is filled with an inert gas such as nitrogen (N₂). That is, the housing portion 107 is hermetically sealed by the cover 105. The internal space of the housing portion 107 is filled with an inert gas.

### <Laser Light Source>

Various types of laser elements can be used as the laser light source 60. For example, commercially available laser diodes (LDs) of red light, green light, blue light, near-infrared light, and the like can be used. Light with a peak wavelength of 600 nm or more and 830 nm or less can be used as red light, light with a peak wavelength of 500 nm or more and 600 nm or less can be used as green light, and light with a peak wavelength of 380 nm or more and 500 nm or the less can be used as blue light. Also, light with a peak wavelength of 830 nm or more and 2000 nm or less can be used as near-infrared light.

In the laser module 1000 shown in FIG. 1A, laser light sources 60-1, 60-2, and 60-3 are assumed to be an LD that emits blue light, an LD that emits green light, and an LD that emits red light, respectively. The LDs 60-1, 60-2, and 60-3 can be mounted on subcarriers 61-1, 61-2, and 61-3, respectively, as bare chips (unpackaged chips) as an example. The subcarriers 61-1, 61-2, and 61-3 are made of, for example, aluminum nitride (AlN), aluminum oxide (Al₂O₃), silicon (Si), or the like.

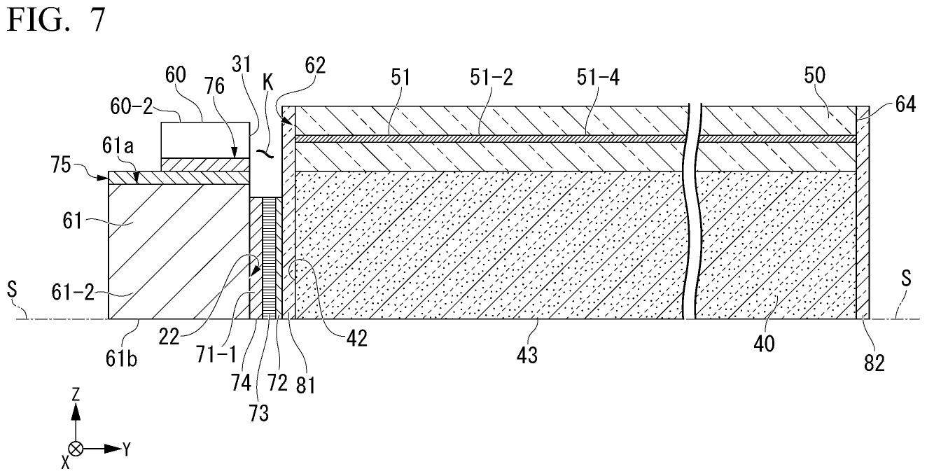

Metallic layers 75 and 76 are provided between the subcarrier 61 and the LD 60 (see FIG. 7). The subcarrier 61 and the LD 60 are connected via the metallic layers 75 and 76. As a method of forming the metallic layers 75 and 76, a known method can be used and is not particularly specified, but a known method such as sputtering, vapor deposition, or application of a pasted metal can be used. The metallic layers 75 and 76 may include, for example, one or more metals selected from the group consisting of gold (Au), platinum (Pt), silver (Ag), lead (Pb), indium (In), nickel (Ni), titanium (Ti), tantalum (Ta), tungsten (W), an alloy of gold (Au) and tin (Sn), a tin (Sn)-silver (Ag)-copper (Cu)-based solder alloy (SAC), SnCu, InBi, SnPdAg, SnBiIn, and PbBiIn or may be composed of one or more metals selected from this group.

### <Output Light Aperture>

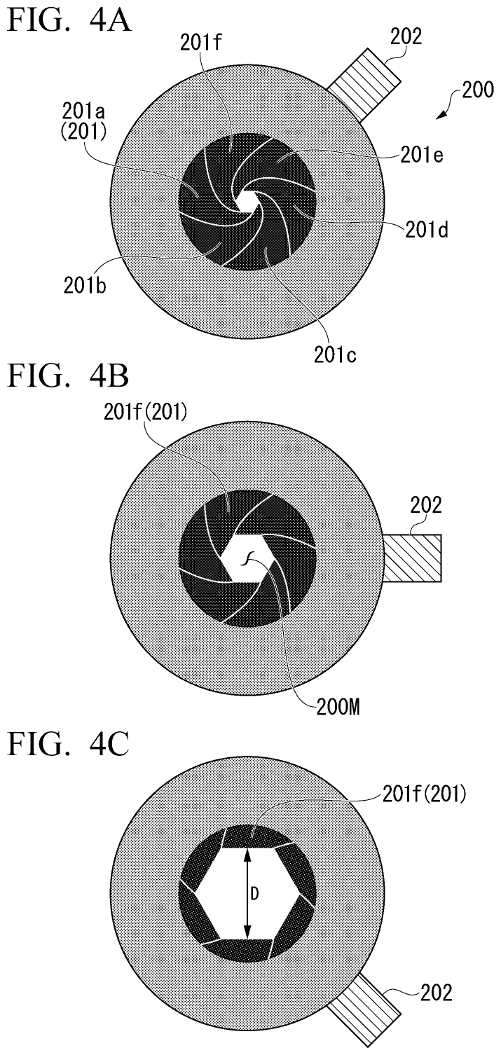

In the laser module 1000 shown in FIG. 1A, the output light aperture 200 is provided outside of the package 100 and arranged in the traveling direction of the laser light L and can adjust an area of an opening (a passage port of the laser light L) 200M of the output light aperture 200 (see FIG. 4B) or a diameter D of the opening 200M (see FIG. 4C). The output light aperture 200 is an aperture with a variable opening area.

The output light aperture 200 has a function of preventing or suppressing leakage of stray light to the outside of the laser module 1000 at portions other than the passage port 200M through which the laser light L passes.

Also, the output light aperture 200 can exhibit a pickup function of allowing only a part of the laser light L desired to be used (for example, a central part of a Gaussian distribution) to pass through. Thereby, it is possible to allow a user to set an optimum beam size.

The output light aperture 200 may apply a known aperture mechanism used for the aperture of a camera.

The output light aperture 200 can be fixed to the package 100 in a known method. For example, a non-movable outer portion of the output light aperture 200 can be attached to the package 100 through adhesion. At this time, the package may be attached by providing a groove to improve the accuracy of an attachment position.

The diameter D of the opening 200M is set to a size in which stray light can be sufficiently suppressed. For example, a minimum size (see FIG. 4A) is about 0.2 to 2 mm and a maximum size (see FIG. 4C) is 1 to 3 mm.

Although a specific size varies with a distance between a laser output part in the package and the package, such a diameter is in a desirable range for a package size of about 40 mm³ to 100 mm³, which is the main point of the present disclosure.

When the laser module according to the present embodiment includes a visible laser light source and an invisible near-infrared laser light source, each of the visible light laser and the near-infrared light laser may include an output light aperture.

The output light aperture 200 may have a plurality of aperture blades, and may be configured to adjust an aperture size or an aperture diameter by moving the aperture blades. The aperture blades may be moved automatically or manually.

The output light aperture 200 may have an adjustment knob that manually moves the aperture blades and may be a mechanism that slides or rotates the adjustment knob to move the aperture blades.

In FIGS. 4A to 4C, an example of the output light aperture 200 is shown.

The output light aperture 200 shown in FIGS. 4A to 4C includes six aperture blades 201 (201a, 201b, 201c, 201d, 201e, and 201f). The output light aperture 200 has the six aperture blades, but the number of aperture blades that is six is an example and the number of aperture blades may be other numbers.

The aperture blades 201 may be made of paper or plastic.

The output light aperture 200 shown in FIGS. 4A to 4C has an adjustment knob 202 for moving the aperture blades 201 to adjust an opening area, an aperture size, or an aperture diameter D.

FIG. 4A shows a state in which the output light aperture 200 closes to the maximum, FIG. 4C shows a state in which the output light aperture 200 opens to the maximum, and FIG. 4B shows an intermediate state therebetween.

The output light aperture 200 may have a positioning mechanism for positioning the adjustment knob.

The positioning mechanism for positioning the adjustment knob may be a plunger.

The plunger is usually cylindrical and has a ball or a pin at the tip thereof. The ball (pin) sinks into the main body when a load is applied, but because it contains a spring, the spring is returned to the original position by the force of the spring when the load is released. In the threaded mounting type, the side of the cylinder is threaded.

From the viewpoint of durability, a plunger body, ball, pin, or spring is preferably made of stainless steel in the plunger.

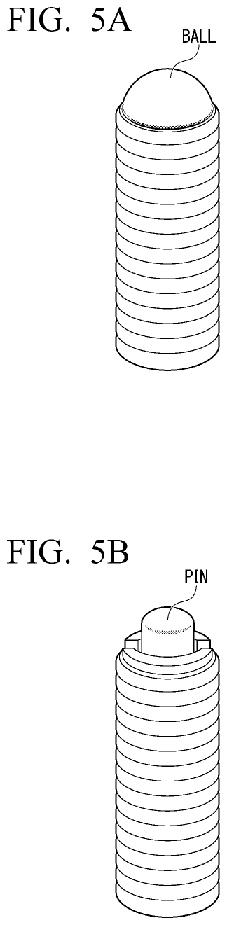

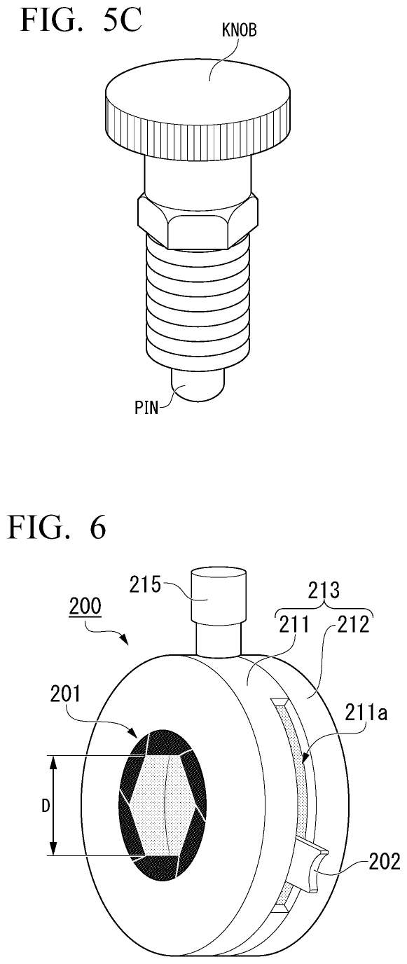

In FIGS. 5A to 5C, examples of a plunger of a representative mechanism are shown.

FIG. 5A shows a ball plunger with a ball at its tip, FIG. 5B shows a pin plunger with a pin at its tip, and FIG. 5C shows an index plunger that is operated with a knob or the like.

The ball plunger shown in FIG. 5A facilitates sliding (sliding and moving) of an object in contact with the ball and is suitable for positioning a sliding portion. Also, because the ball sinks even if a load from the horizontal direction is applied, it is also suitable for positioning the sliding mechanism.

The pin plunger shown in FIG. 5B often has a hemispherical tip or a tapered cylindrical pin. Unlike the ball plunger, a stroke (a maximum length for enabling the ball or pin to sink into the body) can be lengthened.

The index plunger shown in FIG. 5C has a knob on the opposite side of the tip where the pin is located to manipulate the sinking length of the pin. The pin sinks when the knob is pulled and the pin comes out when the knob is pushed. In the index plunger, for example, by pressing the pin against a positioning hole, the pin can be easily fitted into the hole according to the action of the spring, and the positioning process can be easily released by pulling the knob.

The ball plunger will be described in detail with reference to FIG. 6 as an example.

The output light aperture 200 shown in FIG. 6 includes a case member 213 (an upper case portion 211 and a lower case portion 212), an adjustment knob 202, a ball plunger (positioning member) 215, and aperture blades 201.

The aperture blades 201 are provided inside of a rotating member (not shown) arranged in the case member to be rotatable about the optical axis. The adjustment knob 202 protrudes from a notch 211a formed on the outer peripheral surface of the case member. The adjustment knob 202 is formed integrally with the rotating member. By moving the adjustment knob 202 along the notch 211a, the rotating member rotates about the optical axis. Along with the rotation, the aperture blades 201 can perform an aperture operation to change an aperture diameter D.

The ball plunger 215 includes a convex portion inserted into the case member, a coil spring provided in the convex portion, and a ball provided at the tip of the convex portion and biased toward the rotating member by the coil spring. The ball plunger 215 engages with a groove portion formed in the outer peripheral surface of the rotating member as the rotating member rotates by pressing the outer peripheral surface of the rotating member with a ball.

The groove portion is formed at a position corresponding to a type of a desired aperture diameter D that is the aperture diameter D when the ball plunger 215 engages with the groove portion as the rotating member rotates.

### <Optical Waveguide Layer>

The laser module according to the present embodiment can include an optical waveguide layer including an optical waveguide for guiding laser light output from a laser light source in a package. This optical waveguide layer is not particularly limited, and for example, a known configuration can be adopted. Hereinafter, examples of the optical waveguide layer are shown.

The laser module 1000 may include an optical waveguide layer 50 including optical waveguides 51 (51-1, 51-2, and 51-3) that guide laser light output from the laser light source 60 in the package 100. The optical waveguide layer 50 is referred to as a planar lightwave circuit (PLC). Hereinafter, the optical waveguide layer 50 may be referred to as the PLC 50. Also, the optical waveguides 51-1, 51-2, and 51-3 may be referred to as cores 51-1, 51-2, and 51-3.

In the laser module 1000, the optical waveguide layer 50 is formed on the substrate 40 and the laser light source 60 is placed on the subcarrier 61 as described above. The substrate 40 and the subcarrier 61 are metal-bonded and integrated.

This metal bonding enables accurate optical axis arrangement and miniaturization is implemented.

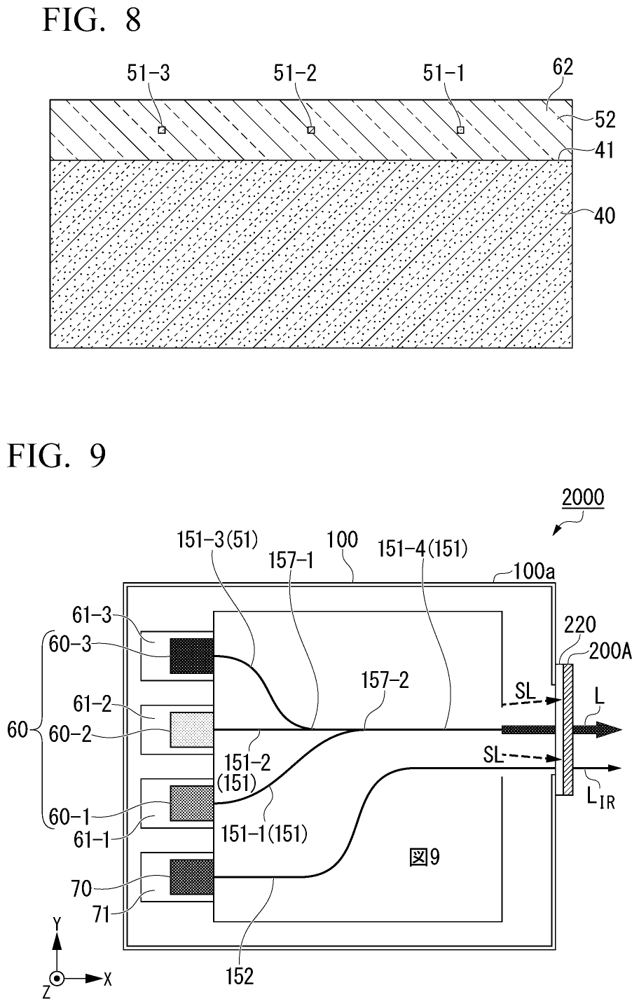

The optical module housed in the package 100 will be described below mainly using the schematic longitudinal cross-sectional view along the x-axis direction shown in FIG. 7 and the schematic plan view of the input surface of the PLC 50 shown in FIG. 8.

The substrate 40 is made of, for example, silicon (Si). The PLC 50 is fabricated integrally with the substrate 40 on a top surface 41 in a known semiconductor process including photolithography and dry etching used when fine structures such as integrated circuits are formed.

As shown in FIGS. 1A and 1B, the PLC 50 includes cores 51-1, 51-2, and 51-3 equal in number to the LDs 60-1, 60-2, and 60-3 and cladding 52 surrounding the cores 51-1, 51-2, and 51-3. A thickness of the cladding 52 and widthwise dimensions of the cores 51-1, 51-2, and 51-3 are not particularly limited. For example, the cores 51-1, 51-2, and 51-3 each having a widthwise dimension of about several microns are arranged in the cladding 52 having a thickness of about 50 μm.

The cores 51-1, 51-2, and 51-3 and the cladding 52 are made of, for example, quartz. Hereinafter, it may be referred to as a quartz-based PLC 50. Refractive indices of the cores 51-1, 51-2, and 51-3 are higher than the refractive index of the cladding 52 by a prescribed value. Thereby, light input to each of the cores 51-1, 51-2, and 51-3 propagates in each core while being totally reflected on the interface between each core and the cladding 52. The cores 51-1, 51-2, and 51-3 are doped with impurities such as germanium (Ge) in an amount corresponding to the aforementioned prescribed value.

As shown in FIGS. 1A, 1B, and 7, the cores 51-1, 51-2, and 51-3 are gathered together on the front side of the PLC 50 reaching the output surface 64. That is, the cores 51-1, 51-2, and 51-3 merge in order toward the front in the x-direction, and merge into one core 51-4. It is preferable to connect the core 51-4 to the cores 51-1, 51-2, and 51-3 each having a radius of curvature greater than or equal to a prescribed radius of curvature so that light leaking from the cores 51-1, 51-2, and 51-3 does not occur.

According to metal bonding between the substrate 40 and the subcarrier 61, each core and an LD corresponding thereto are arranged to face each other in a state in which optical axis alignment is accurately made so that the center of the input port of each of the cores 51-1, 51-2, and 51-3 of the PLC 50 substantially coincides with an optical axis of the output light from the LD 60-1, 60-2, or 60-3 corresponding thereto.

As shown in FIGS. 1A and 1B, after red light, green light, and blue light emitted from the LDs 60-1, 60-2, and 60-3 are input to the cores 51-1, 51-2, and 51-3, respectively, light propagates in each core. The red light and green light propagating in the cores 51-3 and 51-2 are multiplexed at a prescribed merging position 57-1 behind a merging position 57-2 in the x-direction. The red light and green light that are multiplexed and the blue light propagating in the core 51-2 are combined at a merging position 57-2. The RGB light multiplexed at the merging position 57-2 propagates in the core 51-4, reaches the output surface 64, and is output from the output surface 64.

As shown in FIG. 7, the subcarrier 61 is connected to the substrate 40 via, for example, the metallic layers (the first metallic layer 74, the second metallic layer 72, and the third metallic layer 73). In the present embodiment, a side surface (first side surface) 22 of the subcarrier 61 facing the substrate 40 and a side surface (second side surface) 42 of the substrate 40 facing the subcarrier 61 are connected via the first metallic layer 74, the second metallic layer 72, the third metallic layer 73 and an antireflection film 81. A melting point of the metallic layer 75 is higher than a melting point of the third metallic layer 73.

The first metallic layer 74 is provided in contact with the side surface 22 according to sputtering, vapor deposition, or the like, and may include, for example, one or more metals selected from the group consisting of gold (Au), platinum (Pt), silver (Ag), lead (Pb), indium (In), nickel (Ni), titanium (Ti), and tantalum (Ta), or may be composed of one or more metals selected from this group. Preferably, the first metallic layer 74 includes at least one metal selected from the group consisting of gold (Au), platinum (Pt), silver (Ag), lead (Pb), indium (In), and nickel (Ni). The second metallic layer 72 is provided in a state in which it is in contact with the side surface 42 according to sputtering, vapor deposition, or the like, and may include, for example, one or more metals selected from the group consisting of titanium (Ti), tantalum (Ta) and tungsten (W), or may be composed of one or more metals selected from this group. Preferably, tantalum (Ta) is used for the second metallic layer 72. The third metallic layer 73 is interposed between the first metallic layer 74 and the second metallic layer 72, and may include, for example, one or more metals selected from the group consisting of aluminum (Al), copper (Cu), AuSn, SnCu, InBi, SnAgCu, SnPdAg, SnBiIn, and PbBiIn or may be composed of one or more metals selected from this group. Preferably, AuSn, SnAgCu, and SnBiIn are used as the third metallic layer 73.

A thickness of the first metallic layer 74, i.e., a size of the first metallic layer 74 in the y-direction, is, for example, 0.01 μm or more and 5.00 μm or less. A thickness of the second metallic layer 72, i.e., a size of the second metallic layer 72 in the y-direction, is, for example, 0.01 μm or more and 1.00 μm or less. A thickness of the third metallic layer 73, i.e., a size of the third metallic layer 73 in the y-direction, is, for example, 0.01 μm or more and 5.00 μm or less. Also, the thickness of the third metallic layer 73 is preferably larger than the thicknesses of the first metallic layer 74 and the second metallic layer 72.

According to such a configuration, the above-described roles of the first metallic layer 74, the second metallic layer 72, and the third metallic layer 73 are well expressed, and the material entry of the first metallic layer 74 for the substrate 40 and the decrease in the adhesive strength of each metallic layer are suppressed. The thicknesses of the first metallic layer 74, the second metallic layer 72, and the third metallic layer 73 are measured, for example, according to spectroscopic ellipsometry.

In the illustrated laser module 1000, the antireflection film 81 is provided between the LD 60 and the PLC 50. For example, the antireflection film 81 is integrally formed on the side surface 42 of the substrate 40 and the input surface 62 of the PLC 50. However, the antireflection film 81 may be formed only on the input surface 62 of the PLC 50.

In the illustrated laser module 1000, an antireflection film 82 is provided not only on the input surface 62 but also on the output surface 64. Also, in FIGS. 1A and 1B, a schematic configuration of the illustrated laser module 1000 is shown, and the first metallic layer 74, the second metallic layer 72, the third metallic layer 73, and the antireflection films 81 and 82 are omitted.

The antireflection films 81 and 82 are films for preventing input light or output light for the PLC 50 from being reflected in a direction opposite a direction in which the input light enters from the input surface 62 or the output surface 64 to each surface and increasing the transmittance of the input light or the output light. The antireflection films 81 and 82 are multilayer films, each of which is formed of, for example, a plurality of types of dielectrics alternately laminated at a prescribed thickness corresponding to the wavelengths of red light, green light, and blue light that are input light. Examples of the above-described dielectric include titanium oxide (TiO₂), tantalum oxide (Ta₂O₅), silicon oxide (SiO₂), aluminum oxide (Al₂O₃), and the like.

An output surface 31 of the LD 60 and an input surface 62 of the PLC 50 are arranged at a prescribed interval.

The input surface 62 faces the output surface 31 and there is a gap S between the output surface 31 and the input surface 62 in the x-direction. Considering the fact that the laser module 1000 is used for XR glasses, a light intensity required for the XR glasses, and the like, a size of the gap (spacing) 70 in the x-direction is, for example, greater than 0 μm and less than or equal to 5 μm.

The illustrated laser module 1000 is provided so that a bottom surface (base bottom surface) 61b facing a top surface (surface) 61a of a subcarrier (base) 61 and a bottom surface (substrate bottom surface) 43 facing the top surface (surface) 41 of the substrate 40 are positioned on substantially the same plane S as each other. In the laser module 1000, because the subcarrier (base) 61 and the substrate 40 are connected via a metallic layer, the occurrence of position misalignment due to a heating process is remarkably suppressed compared to the case where the connection is made with an adhesive.

Also, the term “substantially the same plane S” mentioned here allows slight misalignment between a bottom surface (base bottom surface) 61b and the bottom surface (substrate bottom surface) 43. Specifically, although the misalignment of a range of 20 μm or less is allowed for the thickness of the substrate 40 along the z-direction, it is preferable that the misalignment be small, the misalignment of a range of lam or less is more preferred, and the misalignment of a range of 5 μm or less is more preferred.

As in the illustrated laser module 1000, if the bottom surface 61b of the subcarrier 61 and the bottom surface 43 of the substrate 40 are formed on substantially the same plane S, both the subcarrier 61 and the substrate 40 can be bonded, for example, on a single plane of a package or heatsink.

Thereby, compared to the case where the bottom surface of the subcarrier and the bottom surface of the substrate are not substantially coplanar and only one of the bottom surfaces can be bonded, the laser module 1000 can efficiently radiate heat generated in the operation of the LD (optical semiconductor device) 60 from both the bottom surface 61b of the subcarrier 61 and the bottom surface 43 of the substrate 40.

Also, as in the illustrated laser module 1000, by providing the bottom surface 61b of the subcarrier 61 and the bottom surface 43 of the substrate 40 on substantially the same plane S, when the optical module is bonded to another substrate or the like on the same plane, because both surfaces of the bottom surface 61b of the subcarrier 61 and the bottom surface 43 of the substrate 40 can be the substrate and the like on the same plane, the laser module 1000 with high bonding strength and excellent impact resistance can be implemented.

For example, when the bottom surface of the subcarrier is located in the +z-direction as compared with the bottom surface of the substrate, i.e., when the bottom surface of the subcarrier is spaced more upward from a base 180 of the package 100 (see FIG. 7) than the bottom surface of the substrate, the size of the first side surface of the subcarrier is small and the heat dissipation cannot be efficiently performed. When the bonding strength with the substrate is not sufficient and wire bonding to be described below is performed, there is a case where the subcarrier slips. However, the illustrated laser module 1000 can improve heat dissipation and impact resistance because a sufficient size of the side surface 22 can be ensured, heat can be radiated from the bottom surface 61b and the side surface 22, and bonding with the substrate 40 can be sufficiently performed.

By improving impact resistance, for example, the LD 60 is maintained at an optimum position with respect to the PLC 50. Therefore, the laser module 1000 can exhibit desired light utilization efficiency and optical characteristics, and the reliability of the laser module 1000 can be improved.

The electrode portion 108 is arranged on the rear side of the housing portion 107 in the x-direction. The upper surface of the electrode portion 108 is positioned below the upper surface of the housing portion 107. The bottom surface of the electrode portion 108 is positioned at substantially the same height as the bottom surface of the housing portion 107. A plurality of external electrode pads 210 are provided on the upper surface of the electrode portion 108 at intervals in the y-direction.

As shown in FIG. 7, the base 180 for installing an optical module including the LD 60, the subcarrier 61 on which the LD 60 is placed, the PLC 50, and the substrate 40 on which the PLC 50 is formed is provided at a prescribed position on the bottom portion of the housing portion 107. This optical module is provided on the base 180. In other words, this optical module is arranged in an internal space of the housing portion 107. Because this optical module is formed so that the bottom surface (base bottom surface) 61b of the subcarrier (base) 61 and the bottom surface (substrate bottom surface) 43 of the substrate 40 are positioned substantially on the same plane S, the subcarrier 61 and the substrate 40 are both bonded to an upper surface 180a (one inner surface) of the base 180 in this optical module.

It is only necessary to bond the bottom surface (base bottom surface) 61b of the subcarrier (base) 61 and the bottom surface (substrate bottom surface) 43 of the substrate 40 to the upper surface 180a (one inner surface) of the base 180 via an adhesive layer 182. The adhesive layer 182 is made of a resin material mixed with a filler to improve thermal conductivity. Examples of the resin constituting the adhesive layer 182 include epoxy resin. Also, copper powder, aluminum powder, alumina powder, or the like can be used as a filler for improving the thermal conductivity of the resin.

Also, in order to maintain thermal conductivity of a certain level or higher, the adhesive layer 182 preferably has a thermal conductivity of 0.5 W/m·K or more, preferably has a thermal conductivity of 1 W/m·K or more, and more preferably has a thermal conductivity of 4 W/m·K or more.

By bonding both the subcarrier (base) 61 of the optical module and the substrate 40 to the upper surface 180a of the base 180 of the package 100 in this way, the heat generated by the operation of the LD 60 can be efficiently radiated from both the bottom surface (base bottom surface) 61b of the subcarrier (base) 61 and the bottom surface (substrate bottom surface) 43 of the substrate 40 toward the base 180. Furthermore, by bonding both the bottom surface (base bottom surface) 61b of the subcarrier (base) 61 and the bottom surface (substrate bottom surface) 43 of the substrate 40 using an adhesive layer made of a resin mixed with a filler, heat can be efficiently propagated from both the bottom surface (base bottom surface) 61b of the subcarrier (base) 61 and the bottom surface (substrate bottom surface) 43 of the substrate 40 toward the base 180.

Next, a case where the optical waveguide of the optical waveguide layer provided in the laser module according to the present embodiment is made of a lithium niobate film (LiNbO₃) will be described (see, for example, Patent Document 4). The optical waveguide layer in this case may be hereinafter referred to as an LN-based PLC.

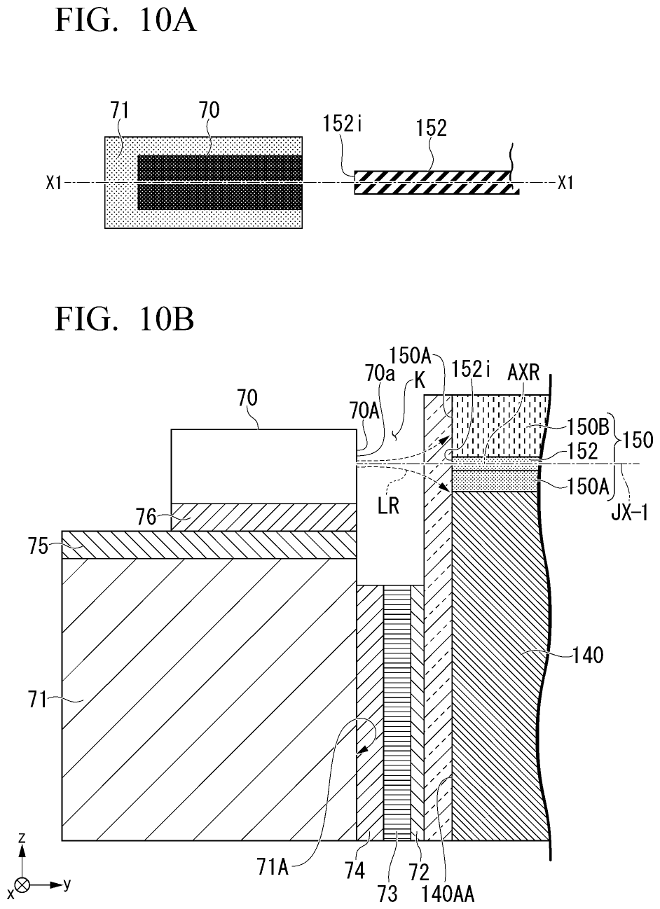

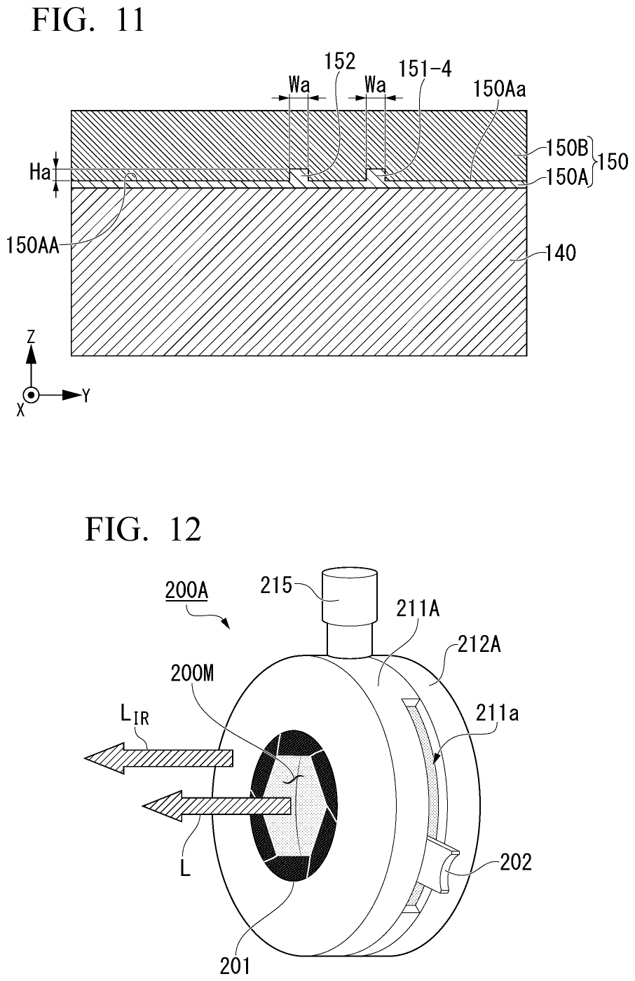

In FIG. 9, a conceptual diagram of a laser module including an optical waveguide layer having an optical waveguide made of a lithium niobate film is shown. FIG. 10A is a schematic plan view obtained by enlarging a region surrounding the near-infrared laser light source and an optical waveguide corresponding thereto, and FIG. 10B is a schematic cross-sectional view along line X1-X1 in FIG. 10A. FIG. 11 is a schematic plan view of the laser module viewed from the output surface of visible laser light and near-infrared laser light.

Members identical to those of the laser module 1000 described above are denoted by the same reference signs, and descriptions thereof may be omitted. In FIG. 9, an example in which the laser module has a near-infrared laser light source as a laser light source in addition to the RGB laser light sources is shown. Because near-infrared lasers are invisible, they can be used for eye tracking.

A laser module 2000 shown in FIG. 9 includes a laser light source 60 and a near-infrared laser light source 70; a package 100 in which the laser light source 60 and the near-infrared laser light source 70 are housed and a light transmission window 101 through which laser light L output from the laser light source 60 and the near-infrared laser light source 70 can be optically transmitted is provided on a wall portion 100a; and an output light aperture 200A provided outside of the package 100 and arranged in a traveling direction of the laser light L to adjust an area of passing of the laser light L.

The near-infrared laser light source 70 is mounted on the subcarrier 71 like the laser light source 60 and the LN-based PLC 150 is formed on the substrate 140.

The laser module 2000 includes the LN-based PLC 150 including the optical waveguides 151 (151-1, 151-2, and 151-3) for guiding the laser light output from the laser light source 60 and the optical waveguide 152 for guiding the near-infrared laser light output from the near-infrared laser light source 70 within the package 100.

Also, in the laser module 2000, the substrate 140 on which the LN-based PLC 150 is formed, the subcarrier 61 on which the laser light source 60 is placed, and the subcarrier 71 on which the near-infrared laser light source 70 is placed are metal-bonded and integrated.

This metal bonding enables an accurate optical axis arrangement and miniaturization is implemented.

Examples of the substrate 140 include a sapphire substrate, a Si substrate, a thermal silicon oxide substrate, and the like.

Although there is no particular limitation as long as the film has a lower refractive index than the lithium niobate film when the optical waveguide 151 and the optical waveguide 152 are formed of a lithium niobate (LiNbO₃) film, a sapphire single-crystal substrate or a silicon single-crystal substrate is preferred as a substrate on which a single-crystal lithium niobate film can be formed as an epitaxial film. Although the crystal orientation of the single-crystal substrate is not particularly limited, for example, because the c-axis-oriented lithium niobate film has 3-fold symmetry, it is preferable that the underlying single-crystal substrate also have the same symmetry and the substrate of the c-plane in the case of a sapphire single-crystal substrate or the (111) plane in the case of a silicon single-crystal substrate is preferred.

In the laser module 2000, the optical waveguide layer (LN-based PLC) 150 includes a waveguide core film 150A having an optical waveguide 151 and an optical waveguide 152 and a waveguide cladding film 150B formed on the waveguide core film 150A to cover the optical waveguide 151 and the optical waveguide 152. The waveguide cladding film 150B has a smaller refractive index than the waveguide core film 150A.

The waveguide cladding film 150B is made of, for example, SiInO, SiO₂, Al₂O₃, MgF₂, La₂O₃, ZnO, HfO₂, MgO, Y₂O₃, CaF₂, In₂O₃, or the like, or a mixture thereof.

Hereinafter, the waveguide core film 150A may be referred to as a lithium niobate film 150A.

The lithium niobate film is, for example, a c-axis-oriented lithium niobate film. The lithium niobate film is, for example, an epitaxial film grown epitaxial on the substrate 140. The epitaxial film is a single-crystal film in which the crystal orientation is aligned by the base substrate. The epitaxial film is a film having a single-crystal orientation in the z-direction and the xy-plane direction and the crystals are aligned and oriented along the x-axis, the y-axis, and the z-axis. It is possible to prove whether or not the film formed on the substrate 140 is an epitaxial film, for example, by confirming the peak intensity and the extreme point at the orientation position in 2θ-θ X-ray diffraction.

The composition of lithium niobate is LiₓNbA_{y}O_{z}. A is an element other than Li, Nb, and O. x is 0.5 or more and 1.2 or less, preferably 0.9 or more and 1.05 or less. y is 0 or more and 0.5 or less. z is 1.5 or more and 4.0 or less, preferably 2.5 or more and 3.5 or less. The element A is, for example, K, Na, Rb, Cs, Be, Mg, Ca, Sr, Ba, Ti, Zr, Hf, V, Cr, Mo, W, Fe, Co, Ni, Zn, Sc, or Ce, and two or more of these elements may be combined.

A thickness of the lithium niobate film is, for example, 2 μm or less. A thickness of the lithium niobate film is a thickness of a portion other than a ridge portion. If the thickness of the lithium niobate film is thick, the crystallinity may deteriorate.

A thickness of the lithium niobate film is, for example, about 1/10 or more of the wavelength of the light that is used. If the thickness of the lithium niobate film is thin, light confinement becomes weak and light leaks to the substrate 140 and the waveguide cladding film 150B.

The optical waveguides 151 and 152 are pathways of light in which light propagates. The optical waveguides 151 and 152 are ridges protruding from a first surface 150AA of the slab layer 150Aa of the lithium niobate film 150A. Hereinafter, the optical waveguides 151-1, 151-2, 151-3, and 152 may be referred to as ridges 151-1, 151-2, 151-3, and 152, respectively. The first surface 150AA is an upper surface of a portion (slab layer 150Aa) other than the ridge portion of the lithium niobate film 150A. The lithium niobate film 150A includes the ridges 151-1, 151-2, 151-3, and 152 and the slab layer 150Aa.

A cross-sectional shape of the cross-sectional shape formation part of the ridge 151-4 and the ridge 152 shown in FIG. 11 is rectangular, but may be any shape as long as light can be guided. For example, it may be trapezoidal, triangular, semicircular, or the like. A width Wa of the ridge in the y-direction is preferably 0.3 μm or more and 5.0 or less, and the height of the ridge (a protruding height Ha from the first surface 150A) is preferably, for example, 0.1 μm or more and 1.0 μm less.

As shown in FIG. 9, the optical waveguides 151-1, 151-2, and 151-3 are gathered together on the front side of the PLC 150 reaching the output surface. That is, the optical waveguides 151-1, 151-2, and 151-3 merge in order toward the front in the x-direction and merge into one optical waveguide 151-4. It is preferable to connect the optical waveguide 151-4 to the optical waveguides 151-1, 151-2, and 151-3 each having a radius of curvature greater than or equal to a prescribed radius of curvature so that light leaking from the optical waveguides 151-1, 151-2, and 151-3 does not occur.

According to metal bonding between the substrate 140 and the subcarriers 61 and 71, each ridge and an LD corresponding thereto are arranged to face each other in a state in which optical axis alignment is accurately made so that the center of the input port of each of the ridges 151-1, 151-2, 151-3, and 152 of the LN-based PLC 50 substantially coincides with an optical axis of the output light from the LD 60-1, 60-2, 60-3, and 70 corresponding thereto.

Input ports 151-1i, 151-2i, 151-3i, and 152i of the optical waveguides 151-1, 151-2, 151-3 and 152 face output ports of LDs 60-1, 60-2, 60-3 and 70 and are positioned so that light output from the output ports of the LDs 60-1, 60-2, 60-3, and 70 can be input to the input ports 151-1i, 151-2i, 151-3i, and 152i, such that the LDs 60-1, 60-2, 60-3, and 70 and the optical waveguides 151-1, 151-2, 151-3, and 152 are optically connected.

For example, an axis JX-1 of the input path substantially overlaps an optical axis AXR of the laser light LR output from an output port 70a of the LD 70. With such a configuration and arrangement, red light, green light, blue light, and near-infrared light emitted from the LDs 60-1, 60-2, 60-3, and 70 can be input to the input paths of the optical waveguides 151-1, 151-2, 151-3, and 152.

As shown in FIG. 9, red light, green light, and blue light emitted from the LDs 60-1, 60-2, and 60-3 are input to the ridges 151-1, 151-2, and 151-3, respectively, and then propagate in the ridges. The red light and green light propagating in the ridges 151-3 and 151-2 are multiplexed at a prescribed merging position 157-1 behind the merging position 157-2 in the x-direction. The red light and green light that are multiplexed and the blue light propagating in the ridge 151-2 are multiplexed at a merging position 57-2. The RGB light multiplexed at the merging position 57-2 propagates in the ridge 151-4, reaches the output surface, and is output from the output surface.

Also, near-infrared light emitted from the LD 70 propagates in the ridge 152, reaches the output surface, and is output from the output surface.

A side surface (first side surface) 71A of the subcarrier 71 facing the substrate 140 and a side surface (second side surface) 10AA of the substrate 140 facing the subcarrier 71 are connected via metallic layers (the first metallic layer 74, the second metallic layer 72, and the third metallic layer 73).

The output light aperture 200A provided in the laser module 2000 is provided outside of the package 100 and arranged in the traveling direction of the visible laser light L and is the same as the output light aperture 200 provided in the laser module 1000 in that an area of an opening (a passage port of the laser light L) of the output light aperture 200A or a diameter of the opening can be adjusted.

On the other hand, in the output light aperture 200A, near-infrared laser light LIR passes through the outer peripheral portion as compared with the aperture blades 201 of the case member 213 (the upper case portion 211 and the lower case portion 212). Such a configuration is, for example, a configuration in which the case member 213 does not pass through (cuts) the visible laser light L, but may be made of a material such as silicon (Si) through which the near-infrared laser beam LIR passes.

Each of the optical waveguides 151-1, 151-2, 151-3, and 152 provided in the LN-based PLC 150 may be a Mach-Zehnder type optical waveguide (see, for example, Patent Document 5).

### [XR Glass] [Optical Engine Module]

In XR glasses according to the present embodiment, any one of the laser modules according to the above-described embodiment is mounted on the glasses.

The XR glasses (eyeglasses) are eyeglasses-type terminals and XR is a general term for virtual reality (VR), augmented reality (AR), and mixed reality.

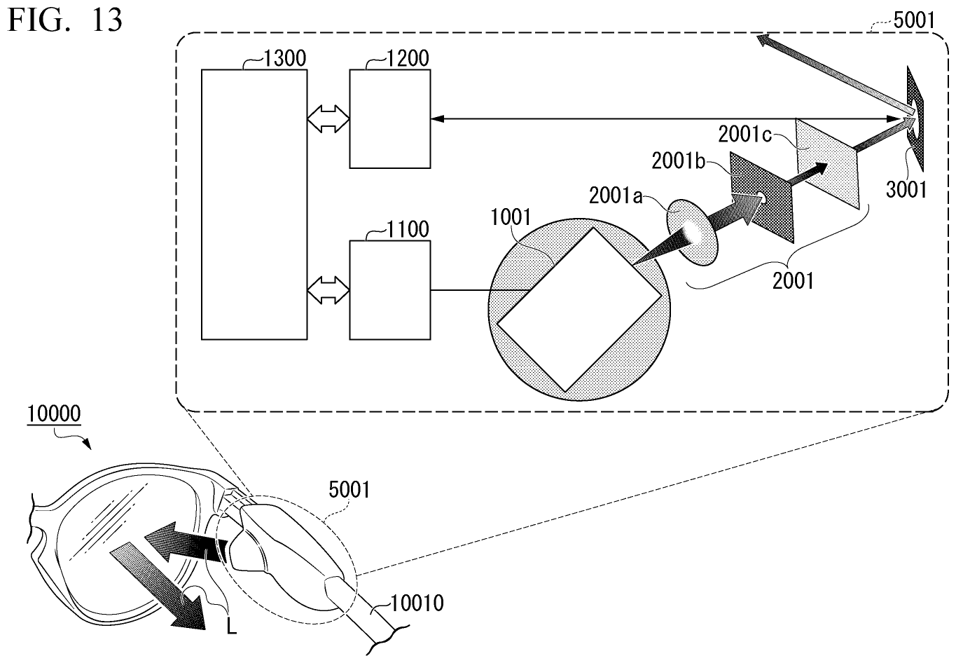

In FIG. 13, a conceptual diagram for describing the XR glasses according to the present embodiment is shown.

XR glasses 10000 shown in FIG. 13 have a laser module 1001 mounted on a frame 10010. Reference sign L denotes image display light.

In FIG. 13, an optical engine 5001 is a combination of the laser module 1001, an optical scanning mirror 3001, and an optics system 2001 connecting the laser module 1001 and the optical scanning mirror 3001 in the present specification. As the laser module 1001, any laser module according to the above-described embodiment is used.

For example, RGB laser light sources, i.e., a red laser light source 60-1, a green laser light source 60-2, and a blue laser light source 60-3, and a near-infrared laser light source 70 can be used as the light source in the laser module 1001.

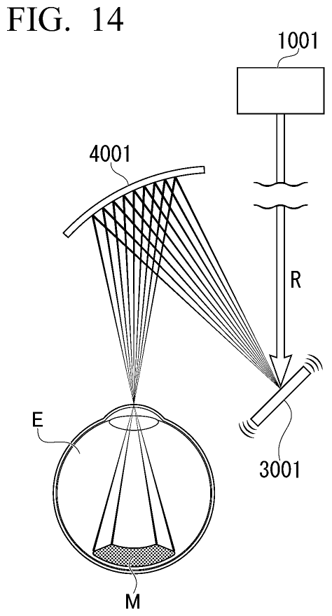

As shown in FIG. 14, laser light applied from the laser module 1001 attached to an eyeglasses frame is reflected by the optical scanning mirror 3001 and the reflected light is reflected toward a person's eyeball E by a mirror 4001 and can enter the eyeball E to project an image (a video) directly onto a retina M.

By providing an eye tracking mechanism, an image is projected directly onto the retina while eye tracking is performed. A known eye tracking mechanism can be used.

The optical scanning mirror 3001 is, for example, a MEMS mirror. In order to project a 2D image, it is preferably a biaxial MEMS mirror that vibrates to reflect laser light by changing an angle in the horizontal direction (X-direction) and the vertical direction (Y-direction).

As the optics system 2001 that optically processes the laser light output from the laser module 1001, a collimator lens 2001a, a slit 2001b, and an ND filter 2001c are provided. This optics system is an example and may have other configurations.

The optical engine 5001 includes a laser driver 1100, an optical scanning mirror driver 1200, and a video controller 1300 that controls these drivers.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

### EXPLANATION OF REFERENCES

60 Laser light source
100 Package
101 Light transmission window
200, 200A Output light aperture
1000, 1000A, 1001, 2000 Laser module
5001 Optical engine
10000 XR glasses

What is claimed is:

1. A laser module comprising:
a laser light source;
a package in which the laser light source is housed and a light transmission window through which laser light output from the laser light source can be optically transmitted is provided on a wall portion; and
an output light aperture provided inside or outside of the package and arranged in a traveling direction of the laser light to adjust an area of a passage port of the laser light.

2. The laser module according to claim 1, wherein the laser light source is a plurality of visible laser light sources each having a wavelength of 380 nm to 800 nm.

3. The laser module according to claim 1, wherein the output light aperture has a plurality of aperture blades.

4. The laser module according to claim 3, wherein the output light aperture has an adjustment knob that moves the aperture blades to adjust an aperture size.

5. The laser module according to claim 4, comprising a positioning mechanism configured to position the adjustment knob.

6. The laser module according to claim 3, wherein the plurality of aperture blades are made of paper or plastic.

7. The laser module according to claim 1, wherein an optical waveguide layer including an optical waveguide that guides laser light output from the laser light source is provided in the package.

8. The laser module according to claim 1, wherein a subcarrier on which the laser light source is placed and a substrate on which an optical waveguide layer is formed are metal-bonded, integrated, and housed in the package.

9. An optical engine module comprising:
the laser module according to claim 1; and
an optical scanning mirror configured to scan light output from the laser module.

10. An optical engine module comprising:
the laser module according to claim 2; and
an optical scanning mirror configured to scan light output from the laser module.

11. An optical engine module comprising:
the laser module according to claim 3; and
an optical scanning mirror configured to scan light output from the laser module.

12. An optical engine module comprising:
the laser module according to claim 4; and
an optical scanning mirror configured to scan light output from the laser module.

13. An optical engine module comprising:
the laser module according to claim 5; and
an optical scanning mirror configured to scan light output from the laser module.

14. An optical engine module comprising:
the laser module according to claim 6; and
an optical scanning mirror configured to scan light output from the laser module.

15. XR glasses comprising the optical engine module according to claim 9.

16. XR glasses comprising the optical engine module according to claim 10.

17. XR glasses comprising the optical engine module according to claim 11.

18. XR glasses comprising the optical engine module according to claim 12.

19. XR glasses comprising the optical engine module according to claim 13.

20. XR glasses comprising the optical engine module according to claim 14.
